(19) United States
(12) Patent Application Publication
(10) Pub. No.: US 2014/0016513 A1
(43) Pub. Date: Jan. 16, 2014

(54) METHODS AND APPARATUS FOR DETERMINING A LANGUAGE

(71) Applicants: Miguel Angel Garcia Martin, Madrid (ES); Ibon Gochi Garcia, Vizcaya (ES)

(72) Inventors: Miguel Angel Garcia Martin, Madrid (ES); Ibon Gochi Garcia, Vizcaya (ES)

(73) Assignee: Telefonaktiebolaget L M Ericsson (PUBL), Stockholm (SE)

(21) Appl. No.: 14/006,889

(22) PCT Filed: Mar. 31, 2011
(86) PCT No.: PCT/EP2011/055003

§ 371 Date: Sep. 23, 2013

(51) Int. Cl. G06F 17/28

(52) U.S. Cl. CPC G06F 17/289
USPC 370/259

(57) ABSTRACT

According to a first aspect of the present invention there is provided a method of operating a telecommunications network to determine a language to be used for a message that is to be sent to a terminal of a user of the network. The method comprises the steps of inspecting packets sent over the network to and/or from a terminal used by the user in order to identify one or more languages specified within application layer protocol information contained in the packets; and selecting an identified language as the language that is to be used for the message.

### TECHNICAL FIELD

The present invention relates to methods and apparatus for determining a language to be used for a message that is to be sent to a terminal of a user of the network.

### BACKGROUND

In mobile telecommunications it may be desirable for the operator of a network to send a message to one or more individuals who are currently using the network. By way of example, a network operator may want to send an SMS to the users to inform them of the current or upcoming status of the network, or a network operator may want to send an MMS to a user, the MMS advertising a special offer provided by the network operator. Typically, network operators will compose any such messages using the domestic/local language associated with their network. However, it will usually be the case that at least some of the individuals currently using the network will not speak the domestic/local language and will therefore be unable to understand messages sent by the network operator to their mobile terminal in this language.

It is possible for network operators to pre-configure their network with data regarding the preferred language(s) of each of the network subscribers, and refer to this information when determining the language that should be used for sending a message to a mobile device used by a user. To do so, information regarding a user's preferences is usually collected at the time the user makes a contract with the network operator or obtains prepaid credit for the operator's network (i.e. when the user subscribes to the network). The network operator can then store the preferred language information of each of its subscribers in one or more databases or registries of subscriber information. However, when a user who has subscribed to a particular home network roams into a visited network, the standardized signalling procedures will cause the nodes of the home network to provide information regarding the user to the nodes of the visited network, but this information will merely be that required to provide mobility to the user and will not include administrative information such as the user's language preferences.

Furthermore, network operators usually separate different aspects of subscriber information into different databases/registries (e.g. for efficiency, legal and/or performance reasons), such that databases used to store subscriber information that is used for administrative purposes (e.g. such as a subscriber's billing address, bank account details, or language preferences) are separate to those used to store the subscriber information required to comply with standardized procedures such as mobility, registration, etc (e.g. databases implementing the functionality of a HSS, HLR, UDR, or SPR). As such, even if a visited network wanted to obtain a roaming user's preferred language information, obtaining this information from the home network is likely to be unfeasible. This static pre-configuration approach is therefore only viable for user's who are located within their home network.

In an attempt to solve this problem, when a network operator wants to send a message to one or more of the users who are currently using the network, the network operator will typically rely on selecting the most common language of the country in which the user's subscription was issued, regardless of whether or not the user can understand that language. For example, when a user holding a subscription with a Spanish operator roams to Sweden, any communications that the operator of the Swedish visited network sends to the user will be sent in Spanish. However, even though the user's subscription was issued by a Spanish operator, the user may not be necessarily be able to understand Spanish. Expanding upon this example, if the user is an Australian citizen living in Spain but who does not understand Spanish, then this approach would mean that the user would not be able to understand any messages sent by the operator of the visited network.

The problem of selecting the language that should be used when sending a communication to a user's terminal is particularly relevant in scenarios of authority-to-citizen emergency communications, where the content of the communication may be vital for ensuring the safety of the user. It is therefore desirable that the operator of a network is able to dynamically determine the language that each user currently using the network can read and understand, and that should therefore be used to compose any messages sent to the user.

### SUMMARY

It is therefore an aim of the present invention to provide method and apparatus for determining a language to be used for a message that is to be sent to a terminal of a user of the network.

According to a first aspect of the present invention there is provided a method of operating a telecommunications network to determine a language to be used for a message that is to be sent to a terminal of a user of the network. The method comprises the steps of:
inspecting packets sent over the network to and/or from a terminal used by the user in order to identify one or more languages specified within application layer protocol information contained in the packets; and
selecting an identified language as the language that is to be used for the message.

This method provides that a network operator can dynamically determine a language that should be used when communicating with a user of the network, and thereby ensure that the user will be able to understand any messages sent by the network operator. Furthermore, the methods and apparatus described above do not require that the network is pre-configured with language information for the user's of the network as the network can determine the appropriate language without any human intervention.

The method may further comprise the step of storing, at a node of the network, information regarding the one or more identified languages in association with the user.

According to a second aspect of the present invention there is provided a method of method of operating a node of a telecommunications network. The method comprises the steps of:
inspecting packets sent over the network to and/or from a terminal used by a user;
identifying, as a result of the inspection, one or more languages specified within application layer protocol information contained in the packets; and
sending a message to a further node, the message including information regarding the one or more identified languages and associating the identified language information with the user such that a language to be used for a further message that is to be sent from the network to a terminal used by the user is selected from the one or more identified languages.

The message may comprise information regarding the one or more identified languages together with an identifier of the user.

The node may be configured to operate as a Traffic Detection Function, TDF. The further node may be configured to operate as:
a Policy and Charging Rules Function, PCRF, or
a user database wherein the user database can be any one of:
   a Subscription Profile Repository;
   a User Data Repository;
   a Home Subscriber Server; and
   a Home Location Register.

The step of inspecting packets may comprise examining field values and/or attribute values of the application layer protocol information contained in the packets in order to detect language tags within the field values and/or attribute values of the application layer protocol information. The field values and/or attribute values that are examined may be one or more of:
“Accept-Language” header field;
“User-Agent” header field;
“Set-Cookie” header field;
“Cookie” header field;
“a=lang” attribute; and
“a=sdplang” attribute.

The application layer protocol information can relate to any one of:
Hypertext Transfer Protocol;
Session Initiation Protocol;
Real Time Streaming Protocol; or
Session Description Protocol.

According to a third aspect of the present invention there is provided a method of operating a node of a telecommunications network. The method comprises the steps of:
receiving a message from a further node that inspects packets sent over the network to and/or from a terminal used by a user, the message including information regarding one or more languages identified by the packet inspection and associating the identified language information with the user; and
storing the identified language information in association with the user within the node or within a user database of the network such that a language to be used for a further message to be sent from the network to a terminal used by the user is selected from the one or more identified languages.

The message may comprise information regarding the one or more identified languages together with an identifier of the user.

The step of storing the identified language information in association with the user may comprise sending a message to a user database of the network, the message including the received language information and associating the language information with the user.

The node may be configured to operate as a Policy and Charging Rules Function. The further node may be configured to operate as a Traffic Detection Function. The user database can be any one of:
a Subscription Profile Repository;
a User Data Repository;
a Home Subscriber Server; and
a Home Location Register.

According to a fourth aspect of the present invention there is provided a method of operating a user database of a telecommunications network, the method comprising the steps of:
receiving a message from a node of the network, the message including information regarding one or more identified languages and associating the identified language information with a user, the identified language information having been obtained as a result of inspecting packets sent over the network to and/or from a terminal used by the user;
storing the identified language information in association with the user; and
upon receipt of a query for language information associated with the user, responding to the query with the identified language information stored in association with the user such that a language to be used for a further message that is to be sent from the network to a terminal used by the user is selected from the one or more identified languages.

The step of storing the identified language information in association with the user may further comprise storing the identified language information in replacement of, or in addition to, language information previously stored by the user database in association with the user. The step of storing the identified language information in association with the user may also further comprise storing a time stamp with the identified language information, the time stamp providing an indication of the time when the identified language information was stored by the user database.

The step of responding to the query with the identified language information stored in association with the user may further comprise selecting the identified language information whose time stamp indicates that the identified language information is the most recent identified language information stored for the user. Alternatively, the step of responding to the query with the identified language information stored in association with the user may further comprise selecting, from among the identified language information stored for the user, the identified language information that, according to the respective time stamps, has been used most frequently within a predefined time period.

According to a fifth aspect of the present invention there is provided a telecommunications network. The telecommunications network comprising:
a first node configured to inspect packets sent over the network to and/or from a terminal used by a user in order to identify one or more languages specified within application layer protocol information contained in the packets and to communicate information regarding the one or more identified languages associated with the user to another node of the network; and
a second node configured to obtain the identified language information associated with the user and use the identified language information to select an identified language as the language to be used for a message that is to be sent by the network to a terminal of the user.

The first node may be configured to communicate the identified language information to the second node. The second node may therefore be configured to receive the identified language information associated with the user from the first node. The second node may be configured to store the identified language information associated with the user.

The telecommunications network may further comprise a third node configured to store the identified language information associated with the user. The first node may be configured to communicate the identified language information to the third node. Alternatively, the first node may be configured to communicate the identified language information to the second node, and the second node may be configured to communicate the identified language information to the third node. The second node may therefore be configured to obtain the identified language information associated with the user from the third node.

The first node may be configured to operate as a Traffic Detection Function. The second node may be configured to operate as a Policy and Charging Rules Function or an Application Function. The third node may be configured to operate as a user database

According to a sixth aspect of the present invention there is provided an apparatus configured to operate as a node of a telecommunications network. The apparatus comprises:
a packet inspection unit for inspecting packets sent over the network to and/or from a terminal used by a user;
a language identification unit for identifying, as a result of the inspection, one or more languages specified within application layer protocol information contained in the packets; and
a transmitter for sending a message to a further node, the message including information regarding the one or more identified languages and associating the identified language information with the user such that a language to be used for a further message that is to be sent from the network to a terminal used by the user is selected from the one or more identified languages.

The node may be configured to operate as a Traffic Detection Function, TDF. The node may be configured to send the message to:
a Policy and Charging Rules Function, PCRF, or
a user database wherein the user database can be any one of:
   a Subscription Profile Repository;
   a User Data Repository;
   a Home Subscriber Server; and
   a Home Location Register.

The packet inspection unit may be configured to examine field values and/or attribute values of the application layer protocol information contained in the packets in order to detect language tags within the field values and/or attribute values of the application layer protocol information. The packet inspection unit may be further configured to examine one or more of:
an “Accept-Language” header field;
a “User-Agent” header field;
a “Set-Cookie” header field;
a “Cookie” header field;
an “a=lang” attribute; and
an “a=sdplang” attribute.

According to a seventh aspect of the present invention there is provided an apparatus configured to operate as a node of a telecommunications network. The apparatus comprises:
a receiver for receiving a message from a further node that inspects packets sent over the network to and/or from a terminal used by a user, the message including information regarding one or more languages identified by the packet inspection and associating the identified language information with the user;
wherein the apparatus is configured to store the identified language information in association with the user within a memory of the node or within a user database of the network, such that a language to be used for a further message to be sent from the network to a terminal used by the user is selected from the one or more identified languages.

The apparatus may further comprise a transmitter for sending a further message to a user database of the network, the further message including the received language information and associating the language information with the user.

The apparatus may be configured to operate as a Policy and Charging Rules Function. The receiver may be configured to receive the message from a Traffic Detection Function. The transmitter may be configured to send the further message to a user database that can be any one of:
a Subscription Profile Repository;
a User Data Repository;
a Home Subscriber Server; and
a Home Location Register.

According to an eighth aspect of the present invention there is provided an apparatus configured to operate as a user database of a telecommunications network. The apparatus comprises:
a receiver for receiving a message from a node of the network, the message including information regarding one or more identified languages and associating the identified language information with a user, the identified language information having been obtained as a result of inspecting packets sent over the network to and/or from a terminal used by the user;
a memory for storing the identified language information in association with the user; and
a query unit for, upon receipt of a query for language information associated with the user, responding to the query with the identified language information stored in association with the user such that a language to be used for a further message that is to be sent from the network to a terminal used by the user is selected from the one or more identified languages.

The apparatus may be configured to store the identified language information in replacement of, or in addition to, language information previously stored by the user database in association with the user. The apparatus may be configured to store a time stamp with the identified language information, the time stamp providing an indication of the time when the identified language information was stored by the user database. When responding to a query, the query unit may be configured to select the identified language information whose time stamp indicates that the identified language information is the most recent identified language information stored for the user. When responding to a query, the query unit may be configured to select, from among the identified language information stored for the user, the identified language information that, according to the respective time stamps, has been used most frequently within a predefined time period.

### BRIEF DESCRIPTION OF THE DRAWINGS

FIG. 1a illustrates schematically an example of a Policy and Charging Control, PCC, architecture in accordance with 3GPP TS 23.203;

FIG. 1b illustrates schematically an example of a PCC architecture in accordance with 3GPP TS 23.203;

FIG. 2 is a signalling flow diagram illustrating an example of the process of a network determining the language to be used for messages that are to be sent to a user by the network;

FIG. 3 is a signalling flow diagram illustrating a further example of the process of a network determining the language to be used for messages that are to be sent to a user by the network;

FIG. 4 is a signalling flow diagram illustrating a yet further example of the process of a network determining the language to be used for messages that are to be sent to a user by the network;

FIG. 5 illustrates schematically an example a mobile telecommunications network system; and

FIG. 6 is a flow diagram illustrating an example an example of the process of a network determining the language to be used for messages that are to be sent to a user by the network.

### DETAILED DESCRIPTION

In order to overcome the limitations identified above there will now be described a method of determining a language that is to be used for communicating with a user that is currently using a telecommunications network. The method involves inspecting the content of data packets sent over the network by a terminal used by the user in order to identify any indication of the user's preferred languages that is contained within application layer protocol information, and using an identified language when sending communications from the network to the user. In doing so, it is recognised here that many of the application layer protocols will convey language information within their signalling messages, and that by inspecting packets in order to identify language information contained within the headers or attributes belonging to the application layer protocols, it is possible to determine the language(s) that a user currently using the network can read and understand.

In doing so, it is recognised here that, when a user installs an application such as a web browser, a streaming client, an IP Multimedia Subsystem, IMS, client etc, on their terminal, the application determines one or more default languages that are to be used by the application. These default languages are typically those that have been selected for use on that terminal (e.g. that are used by the operating system running on the terminal), are determined from the language used by the program that drives the installation of the application, or can be selected by the user prior to, during or after installation of the application. Therefore, when the application generates and sends signalling messages using an associated application layer protocol, an indication of these one or more default languages will be included within certain relevant headers and/or attributes of these messages.

By way of example, application layer protocols such as HTTP, SIP and RTSP can include the “Accept-Language” header field in a message. The “Accept-Language” header field is used to indicate the preferred languages that are to be used for reason phrases, session descriptions, or content included in responses. Language tags, as defined in IETF RFC 5646, as are used within the “Accept-Language” header field to identify the preferred language(s), and each language may be given an associated quality value which represents an estimate of the user's preference for the language. For example,
Accept-Language: en-us, en;q=0.7, es;q=0.3
   would indicate that a user prefers US English, will accept other types of English as a preferred alternative and will also accept Spanish.

Other header fields can also provide an indication of a users' preferred language(s). For example, the User-Agent header field is used to convey a string that provides information about the user agent originating the request. This string can often include an embedded representation of a language used by the user agent, and which is therefore likely to also be a language of preference of the user. For example,
User-Agent: Mozilla/5.0 (Windows; U; Windows NT 6.0;
en-US; rv:1.9.2.13) Gecko/20101203 Firefox/3.6.13 GTB7.1
   could indicate that the user prefers US English.

In addition, some web servers store cookies on a user's device in order to store the user's preferences regarding a particular website. A cookie consists of one or more name-value pairs containing bits of information, and is often used to store a user's preferred language information after the user has selected a language in which they wish to view a website. The cookie is defined in the “Set-Cookie” header field of the HTTP response sent by a web server to a web browser application. This cookie is then sent back unchanged in the “Cookie” header field each time the web browser application accesses that web server. For example,
Cookie: ID=49ad50: LANG=es
   would indicate that a user prefers Spanish.

Similarly, as the cookie is defined in the “Set-Cookie” header field of the HTTP response sent by a web server to a web browser application, the value of the “Set-Cookie” header field could also be analysed in order to detect an indication of a users' preferred language(s). For example,
Set-Cookie: ID=49ad50: LANG=es
   would also indicate that a user prefers Spanish. However, as this header field is included in a response sent to the terminal, packet inspection of packets sent to the terminal over the network should also be possible.

As a further example, application layer protocols such as SDP (see IETF RFC 4566) can include a value attribute line “a=lang”. The “a=lang” value attribute is used to specify the default language for the session being described or the language for some described media. The “lang” attribute value must be a single language tag. For example,
a=lang: en-us
   would indicate that a user prefers US English. Similarly, SDP can include a value attribute line “a=sdplang”. The “a=sdplang” value attribute is used to specify the language for the session description or the language for any media-level SDP information field associated with that media. For example:
a=sdplang: en-us
   would indicate that a user prefers US English.

In order to detect and extract information from application layer, the content of data packets sent from a user's mobile terminal must be inspected and analysed beyond the so-called “5-tuple”. The “5-tuple” consists of the source IP address, destination IP address, source transport layer address (e.g. TCP/UDP port), destination transport layer address (e.g. TCP/UDP port), and the next level protocol used in the data portion of packet (e.g. TCP, UDP, ICMP etc). Deep Packet Inspection (DPI) techniques can therefore be used, as DPI involves looking beyond the header information corresponding to the network (L3) and transport (L4) levels, and inspecting the content or payload of packets, up to layer 7 of the OSI model. Preferably, this DPI functionality should be provided within a node that performs application traffic detection and that is located within the path taken by data packets, or within a node that is responsible for routing the data packets.

The preferred language information obtained for the user from the application layer protocols can then be stored by the network, such that this information can subsequently be used by the network to determine the language that should be used for a message that is to be sent to the user by the network. In addition, if the application layer protocol information within data packets subsequently sent over the network by a terminal used by the user includes indications that the user's preferred language(s) differ to those detected in earlier data packets, then the most recently detected indications can be used to dynamically update the user's language information. Moreover, if as a result of inspecting multiple data packets sent over the network by the mobile terminal, the network detects multiple divergent results for the user's preferred language(s), then the network can make use of rule based mechanisms to determine which of the multiple languages should be used. For example, the network could apply a majority rule based mechanism.

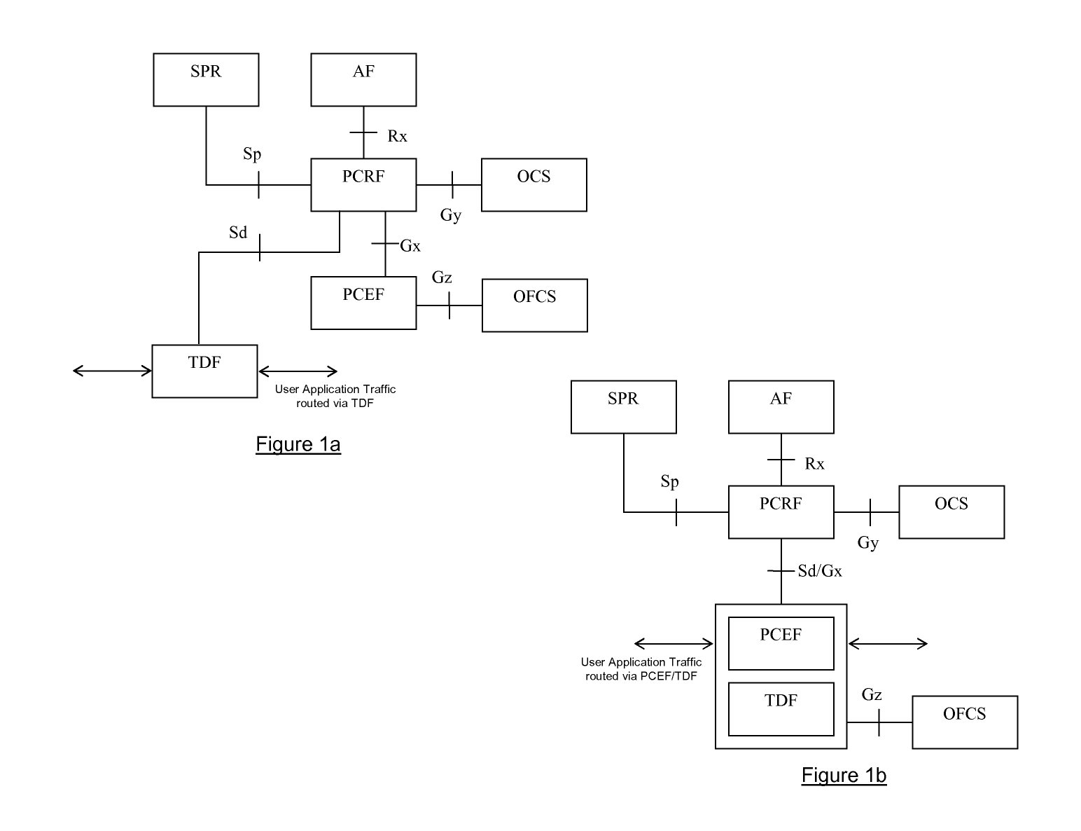

In order to implement the method, a telecommunications network can make use of the elements of a Policy and Charging Control (PCC) architecture that are incorporated into the network. 3GPP TS 23.203 V11.0.1 describes such a PCC architecture in respect of packet flows in an IP-CAN session established by a user terminal through a telecommunications system, including both 3GPP accesses (GERAN/UTRAN/E-UTRAN) and Non-3GPP accesses. FIGS. 1a and 1b illustrates schematically examples of the PCC architecture described in 3GPP TS 23.203 V11.0.1 that comprises a Policy and Charging Enforcement Function (PCEF), a Policy and Charging Rules Function (PCRF), an Application Function (AF), a Traffic Detection Function (TDF), an Online Charging System (OCS), an Offline Charging System (OFCS) and a Subscription Profile Repository (SPR). The TDF is a functional entity that performs application detection and reporting of a detected application and its service data flow description to the PCRF.

In this regard, FIGS. 1a and 1b illustrate functional entities (e.g. PCRF, PCEF, TDF, etc) for each of which 3GPP TS 23.203 V11.0.1 defines the minimum functionality in terms of capabilities (such as processing, storage, communication etc) that is to be implemented by nodes of a telecommunications system. Accordingly, the skilled person can envisage technical realisations comprising standalone nodes configured to operate so as to provide the functionalities of a single one of these entities, and/or comprising nodes configured to operate so as to provide the functionalities or more than one of these entities (i.e. co-located within a single node). For example, chapters 6.2.2.1 and 6.2.9 of 3GPP TS 23.203 V11.0.1 describe the co-location of the PCEF and TDF functionalities. It is therefore noted that when these functional entities are referred to herein, these functional entities could be implemented within a node arranged to operate so as to provide only one of these functionalities, or equally by a node arranged to operate so as to provide more than one of these functionalities.

In FIG. 1a the TDF has been illustrated as a standalone entity. However, the TDF functionality can also be provided by a node that also implements the PCEF functionality (such as a “Gateway GPRS Support Node, GGSN”, or a “Packet Data Network Gateway node, PDN-GW), which is enhanced with TDF capabilities, as illustrated in FIG. 1b in which the same node encompasses TDF and PCEF functionalities.

In particular, as any node that provides the functionality of the TDF will be required to perform some kind of DPI (e.g. so as to able detect the application layer protocol used in a data communication), such a node can be modified to detect application layer protocol information elements that convey language information. A node implementing a standalone TDF, or a node implementing a PCEF enhanced with TDF capabilities, such as a PDN-GW/GGSN, would therefore be ideal for identifying language information that is contained in the application layer protocol information.

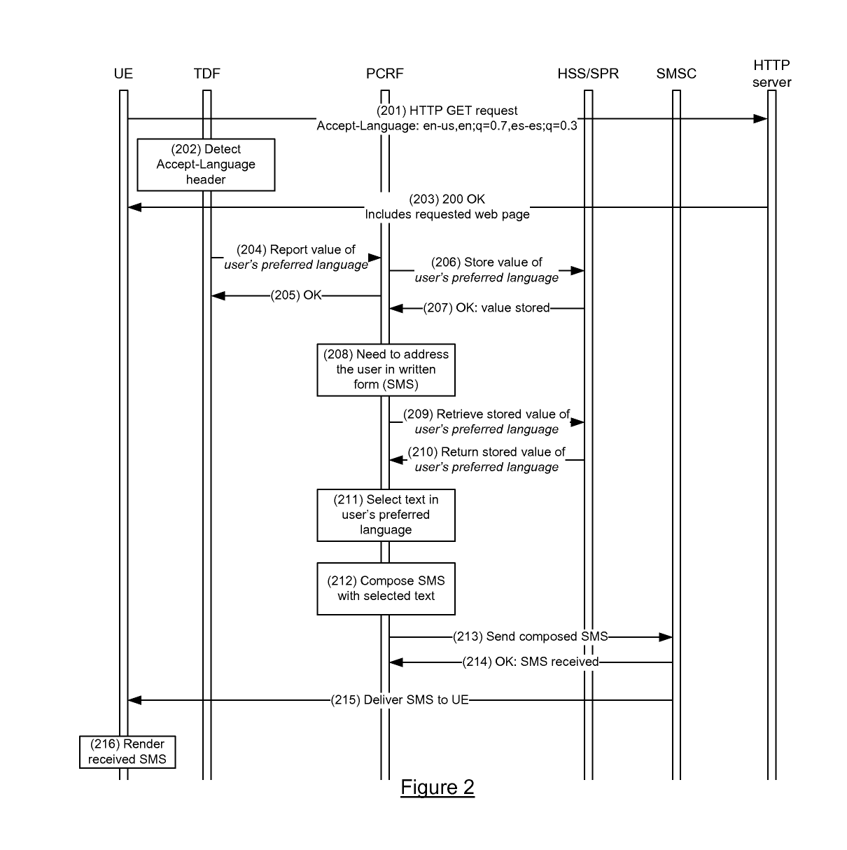

FIG. 2 is a signalling flow diagram illustrating an example of the process of a network determining the language to be used for messages that are to be sent to a user by the network. The steps performed are as follows:
S201. The user uses their terminal/user equipment (UE) to access a web service using the HTTP protocol. To do so, the UE generates a HTTP GET request that is sent over the network, as one or more packets, towards a HTTP server. This request includes an “Accept-Language” header field that indicates the preferred language(s) of the user. The “Accept-Language” header field can include a list of one or more languages and can also include an estimate of the user's preference for each of those languages.
S202. A TDF within the network receives the packet(s) that comprise the HTTP GET request en route towards the HTTP server. The TDF inspects the packet(s) in order to identify any languages that are specified within application layer protocol information contained in the packets. In this case, the TDF identifies the “Accept-Language” header field and extracts the language information provided by the field value. The TDF can temporarily store the language information extracted from the HTTP GET request as the user's preferred language information.
S203. In response to receipt of the HTTP GET request, the HTTP server returns the requested web page in accordance with standard procedures.
S204. The TDF notifies a PCRF of the user's preferred language information. For example, the TDF could send a Diameter Credit Control Request (CCR) message to the PCRF over the Sd interface, the CCR message including the identified language information together with an identifier of the user (e.g. the user's IMSI, MSISDN, IP address, etc). This could be achieved by extending the Sd Diameter protocol specification to define a new Preferred-Language Attribute-Value-Pair (AVP). The Preferred-Language AVP could then be used to carry the identified language information.
S205. The PCRF acknowledges the reception of the message carrying the language information that is associated with the user. For example, the PCRF could send a Diameter Credit Control Answer (CCA) message to the TDF over the Sd interface.
S206. The PCRF then ensures that the user's preferred language information received from the TDF is stored in a record pertaining to the user. Preferably, the received language information is stored in a user database, such as an SPR, HLR, HSS, or UDR; thereby allowing other applications to retrieve the language information that is associated with the user. For example, the PCRF could send a Diameter Profile Update Request (PUR) message to the SPR/HSS over the Sp interface, the PUR message including the identified language information together with an identifier of the user. This could be achieved by extending the Sp protocol specification to include the Preferred-Language AVP. The Preferred-Language AVP could then be used to carry the user's language information. As an alternative example, if the user database (illustrated in the figure as “HSS/SPR”) comprises a User Data Repository (UDR), which is accessed using the so-called Ud interface; then the LDAP protocol defined by 3GPP TS 29.335 can be extended so as to convey a user's language information when requests are sent to the UDR to store and/or retrieve information relating to the user.
S207. The database then acknowledges the storage of the user's language information in the identified user's record. For example, a SPR could send a Diameter Profile Update Answer (PUA) message to the PCRF over the Sp interface. Similarly, in the case of a UDR, the UDR will reply with an LDAP AddResponse or ModifyResponse to the PCRF over the Ud interface
S208. At some later time, the PCRF is required to send a communication to the user. For example, following a message received at the PCRF from the OCS, the PCRF may be required to send a message notifying the user that a monthly download quota has been exhausted. In order to implement such communications, the PCRF can be provisioned with template text for Short Message Service (SMS) messages that can be sent to a user, and the template that is used depends upon the reason for the communication. In addition, each template message can be provided in a number of different languages.
S209. The PCRF is therefore required to determine which language should be used to for a message that is to be sent to the user. To do so, the PCRF will query the database that stores the user's language information. For example, the PCRF can send a Diameter User Data Request (UDR) message to the SPR over the Sp interface. This request can comprise AVP(s) that explicitly request the language information associated with a user, or AVP(s) that request a set of data associated with a user and that can comprise, amongst other data, the user's preferred language information. Similarly, in the case of a UDR, the PCRF would send in this step an LDAP SearchRequest message to the UDR over the Ud interface.
S210. The database responds to the query with the language information that has been stored for the user. For example, a SPR can send a Diameter User Data Answer (UDA) message to the PCRF over the Sp interface. The Preferred-Language AVP could be used within said message to carry the user's language information. Similarly, in the case of a UDR, the UDR would send in this step an LDAP SearchAnswer message to the PCRF.
S211. The PCRF then uses the language information received from the database to determine the language that should be used to communicate with user. For example, the PCRF could analyse the information and select the language with the highest preference/priority value. However, the template messages may only be available in a limited number of languages, such that the PCRF will also have to consider which of the user's preferred languages it is capable of communicating in, and therefore select a language from the user's language information in which it is able to communicate with the user. By way of example, the PCRF may be provided with message templates in Spanish, French, and English, and the user's language information could indicate that Swahili is the language with the highest preference/priority value and that English is a preferred second option. The PCRF will therefore select English as the language that should be used for a message that is to be sent to the user, and will generate a message to the user using the English language version of the message template.
S212. The PCRF composes a text message using the selected language. For example, if the message relates to the users' monthly download quota, this may involve using the template message in the selected language, and completing the message by inserting the user's first name, indicating the user's current consumption of download quota, and adding any other user relevant data. The PCRF is therefore able to compose a personalized message in one of the user's preferred languages such that the message can be understood by the user.
S213. The PCRF delivers the composed text message to a Short Message Service Center (SMSC) using the Short Message Peer-to-Peer (SMPP) protocol.
S214. The SMSC responds to the PCRF to acknowledge receipt of the SMS message.
S215. The SMSC then forwards the SMS to the users' UE.
S216. The users' UE receives the SMS and renders the content of the received SMS to the user.

In the above example, following receipt of a user's language information from a node operating as either a standalone TDF or a TDF co-located with a PCEF, it is the PCRF that initiates storage of the user's language information in a database such as a SPR. However, it is also possible that the node operating as a TDF could itself initiate storage of the preferred language information in a user database, rather than the PCRF. In this regard, whilst the PCC architecture and interfaces described by 3GPP TS 23.203, and as illustrated by FIGS. 1a and 1b, do not envisage a direct interface between a node implementing a TDF and a node implementing a SPR, the node implementing the TDF functionality could use any existing interface to directly accomplish the storage of a user's language information in any node storing user related data For example, a node implementing a TDF could use the so called Ud interface, as described above, to directly instruct a node implementing a UDR to store a user's language information using an LDAP message. By way of further example, a node implementing a TDF could use the so called Sh interface to communicate with a HSS.

In addition, it is also possible that the PCRF could store the language information of a user in a database that is internal to/collocated with the PCRF. The PCRF would then not be required to contact an external database, such as the SPR/HSS, to retrieve a user's language information, but would merely need to retrieve it from this local database.

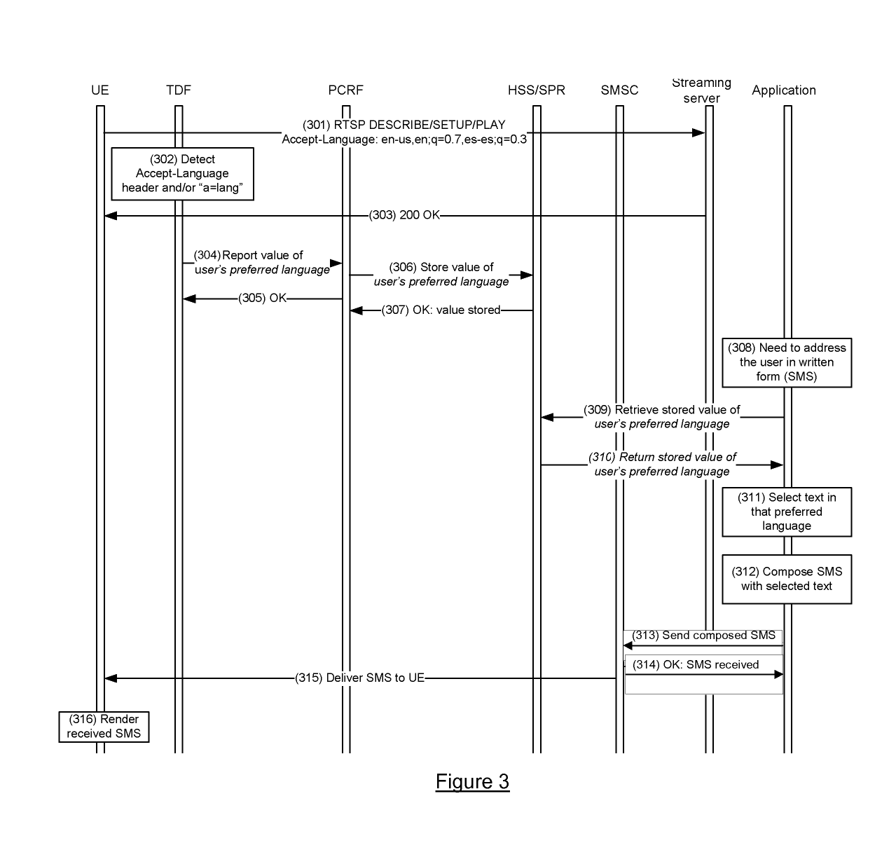

FIG. 3 is a signalling flow diagram illustrating a further example of the process of a network determining the language to be used for messages that are to be sent to a user by the network. The steps performed are as follows:
S301. The user uses their terminal/user equipment (UE) to download a video clip using the RTSP protocol. To do so, the terminal exchanges messages with a streaming media server. These messages include DESCRIBE, SETUP, and PLAY requests sent over the network, as one or more packets, towards the server. Each of these requests can include the “Accept-Language” header field that indicates the preferred language(s) of the user.
S302. For each of these requests, a TDF within the network receives the packet(s) that comprise the request en route towards the server. The TDF inspects the packet(s) in order to identify any languages that are specified within application layer protocol information contained in the packets. In this case, the TDF identifies the “Accept-Language” header field and extracts the language information provided by the field value. The TDF can temporarily store the language information extracted from the request as the user's preferred language information.
S303. After receiving and interpreting a request message, the server responds with an RTSP response message.
S304. The TDF notifies a PCRF of the language information that has been identified for the user. For example, the TDF could send a Diameter CCR message to the PCRF over the Sd interface, the CCR message including the identified language information together with an identifier of the user.
S305. The PCRF acknowledges the reception of the message carrying the user's language information. For example, the PCRF could send a Diameter CCA message to the TDF over the Sd interface.
S306. The PCRF then ensures that the user's language information received from the TDF is stored in a record pertaining to the user. Preferably, the received language information is stored in a database, such as a SPR/HSS. For example, the PCRF could send a Diameter PUR message to the SPR/HSS over the Sp interface, the PUR message including the identified language information together with an identifier of the user.
S307. If the database already stores language information for the user (e.g. language information identified in an earlier message), then the database can replace the earlier language information with the most recently received language information. Alternatively, on each occasion that the database receives language information for the user, the database can store this information together with a time stamp that indicates when the information was received and/or stored, and can therefore be used to determine, from among a plurality of languages which have been identified for a user, the language that is be used for sending a message to said user. The database acknowledges that the identified language information has been stored in the user's record. For example, a SPR/HSS could send a Diameter PUA message to the PCRF over the Sp interface.
S308. At some later time, an Application Function (AF), such as an application server implementing a publicity application, requires that a communication be sent to the user. In order to implement such communications, the AF can be provisioned with template text for Short Message Service (SMS) messages that can be sent to a user, and each template message can be provided in a number of different languages.
S309. The AF is therefore required to determine which language should be used for a message that is to be sent to the user. To do so, the AF will query the database that stores the user's language information. For example, the AF could send a Diameter User Data Request (UDR) message to the SPR/HSS over the Sh interface, or possibly over the Sp interface.
S310. The database responds to the query with the language information that has been stored for the user. For example, a SPR/HSS could send a Diameter User Data Answer (UDA) message to the AF over the Sh/Sp interface. The Preferred-Language AVP could be used to carry the user's language information.
S311. The AF then uses the language information received from the database to determine the language that should be used to communicate with user. For example, the AF could analyse the information and select the language with the highest preference/priority value. However, the template messages may only be available in a limited number of languages, such that the AF will also have to consider which of the languages that are identified in the user's language information it is capable of communicating in, and therefore select a language in which it is able to communicate with the user.
S312. The AF generates a message to the user using a version of the message template that is provided in the selected language such that the message can be understood by the user.
S313. The AF delivers the composed text message to a Short Message Service Center (SMSC) using the Short Message Peer-to-Peer (SMPP) protocol.
S314. The SMSC responds to the AF to acknowledge receipt of the SMS message.
S315. The SMSC then forwards the SMS to the users' UE.
S316. The users' UE receives the SMS and renders the content of the received SMS to the user.

If a user database stores a time stamp together with language information associated with a user, then this time stamp information can be used to select a language from plurality of languages that have been identified for the user. For example, if the packet inspection has identified more than one language within application layer protocol information contained in packets sent to/from a user, but only a subset of these languages are available for use by the network (e.g. the network can only generate messages in certain languages), then this time stamp information can be used to select the most recently identified language that coincides/corresponds with the languages available to the network. As an alternative example, if the packet inspection has identified more than one language within application layer protocol information contained in packets sent to/from a user, then the time stamp information can be used to select the language that has been identified with the greatest frequency for the user within a give time period.

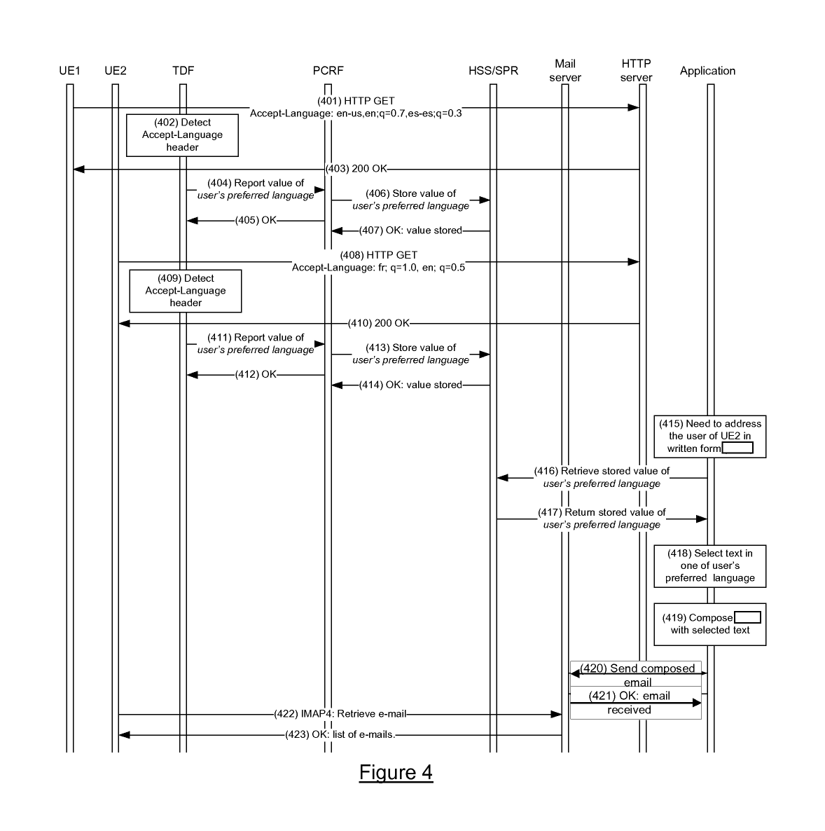

FIG. 4 is a signalling flow diagram illustrating a yet further example of the process of a network determining the language that should be used for a message that is to be sent to a user. In this example, a first user and a second user with different preferred languages (e.g. a multilingual family) are making use of a shared/common mobile subscription, wherein a WLAN router bridges between a WLAN and the mobile terminals used by the individuals, such that the data from these mobile terminals is merged when sent over the network. As such, whilst two different individuals are accessing the network using different UEs (e.g. UE1 and UE2 respectively), from the point of view of the network, a single subscriber is accessing the network using two different UEs. The steps performed are as follows:
S401. The first user uses their mobile terminal/user equipment (UE1) to access a web service using the HTTP protocol. To do so, UE1 generates a HTTP GET request that is sent over the network, as one or more packets, towards a HTTP server. This request includes an “Accept-Language” header field that indicates the preferred language(s) of the first user. The “Accept-Language” header field can include a list of more than one language and can also include an estimate of the first user's preference for each of those languages.
S402. A TDF within the network receives the packet(s) that comprise the HTTP GET request en route towards the HTTP server. The TDF inspects the packet(s) in order to identify any languages that are specified within application layer protocol information contained in the packets. In this case, the TDF identifies the “Accept-Language” header field and extracts the language information provided by the field value. The TDF can temporarily store the language information extracted from the HTTP GET request as the first user's preferred language information.
S403. In response to receipt of the HTTP GET request, the HTTP server returns the requested web page in accordance with standard procedures.
S404. The TDF notifies a PCRF of the first user's language information. For example, the TDF could send a Diameter CCR message to the PCRF over the Sd interface, the CCR message including the identified language information together with an identifier of the first user (e.g. the user's IMSI, MSISDN, IP address, etc).
S405. The PCRF acknowledges the reception of the message carrying the first user's language information. For example, the PCRF could send a Diameter CCA message to the TDF over the Sd interface.
S406. The PCRF then ensures that the first user's language information received from the TDF is stored in the record pertaining to the user. Preferably, the received language information is stored in a database, such as an SPR/HSS, thereby allowing other applications to retrieve the first user's language information. For example, the PCRF could send a Diameter PUR message to the SPR/HSS over the Sp interface, the PUR message including the language information together with an identifier of the first user.
S407. The database then acknowledges the storage of the first user's language information in the user's record. For example, a SPR/HSS could send a Diameter PUA message to the PCRF over the Sp interface.
S408. At some later time, the second user uses their mobile terminal/user equipment (UE2) to access a web service using the HTTP protocol. To do so, UE2 generates a HTTP GET request that is sent over the network, as one or more packets, towards a HTTP server. This request includes an “Accept-Language” header field that indicates the preferred language(s) of the second user. The “Accept-Language” header field can include a list of more than one language and can also include an estimate of the second user's preference for each of those languages.
S409. A TDF within the network receives the packet(s) that comprise the HTTP GET request en route towards the HTTP server. The TDF inspects the packet(s) in order to identify any languages that are specified within application layer protocol information contained in the packets. In this case, the TDF identifies the “Accept-Language” header field and extracts the language information provided by the field value. The TDF can temporarily store the language information extracted from the HTTP GET request as the first user's preferred language information.
S410. In response to receipt of the HTTP GET request, the HTTP server returns the requested web page in accordance with standard procedures.
S411. The TDF notifies a PCRF of the second user's language information. For example, the TDF could send a Diameter CCR message to the PCRF over the Sd interface, the CCR message including the identified language information together with an identifier of the second user.
S412. The PCRF acknowledges the reception of the message carrying the second user's language information. For example, the PCRF could send a Diameter CCA message to the TDF over the Sd interface.
S413. The PCRF then ensures that the second user's language information received from the TDF is stored in the record pertaining to the user. Preferably, the received language information is stored in a database, such as an SPR/HSS, thereby allowing other applications to retrieve the second user's language information. For example, the PCRF could send a Diameter PUR message to the SPR/HSS over the Sp interface, the PUR message including the user's language information together with an identifier of the second user.
S414. The database then acknowledges the storage of the second user's language information in the user's record. For example, a SPR/HSS could send a Diameter PUA message to the PCRF over the Sp interface.
S415. At some later time, an AF requires that a communication be sent to the second user. In order to implement such communications, the AF can be provisioned with template text for email messages that can be sent to a user, and each template message can be provided in a number of different languages.
S416. The AF is therefore required to determine which language should be used to communicate with second user. To do so, the AF will query the database that stores the second user's language information. For example, the AF could send a Diameter UDR message to the SPR/HSS over the Sh/Sp interface.
S417. The database responds to the query with the language information that has been stored for the second user. For example, a SPR/HSS could send a Diameter UDA message to the AF over the Sh/Sp interface. The Preferred-Language AVP could be used to carry the second user's language information.
S418. The AF then uses the language information received from the database to determine the language that should be used to communicate with second user. For example, the AF could analyse the information and select the language with the highest preference/priority value. However, the template messages may only be available in a limited number of languages, such that the AF will also have to consider which of the languages that are identified in the second user's language information it is capable of communicating in, and therefore select a language in which it is able to communicate.
S419. The AF generates an email message to the second user using a version of the message template that is provided in the selected language such that the message can be understood by the second user.
S420. The AF delivers the email message to a mail server.
S421. The mail server responds to the AF to acknowledge receipt of the email message.
S422. The second users' UE (UE2) then requests their emails from the mail server in accordance an email protocol such as the Internet Message Access Protocol (IMAP).
S423. The mail server then sends the second users email to UE2 including the email message from the AF.

It is worth noting that, if the network had determined the preferred language by reference to the owner of the subscription (i.e. the first user), in accordance with conventional procedures, then the AF would have chosen to communicate with the second user in the preferred language of the first user. This could result in the sending a message to the second user in language that they cannot understand. However, this problem is avoided when the language of communication is determined using the methods described above.

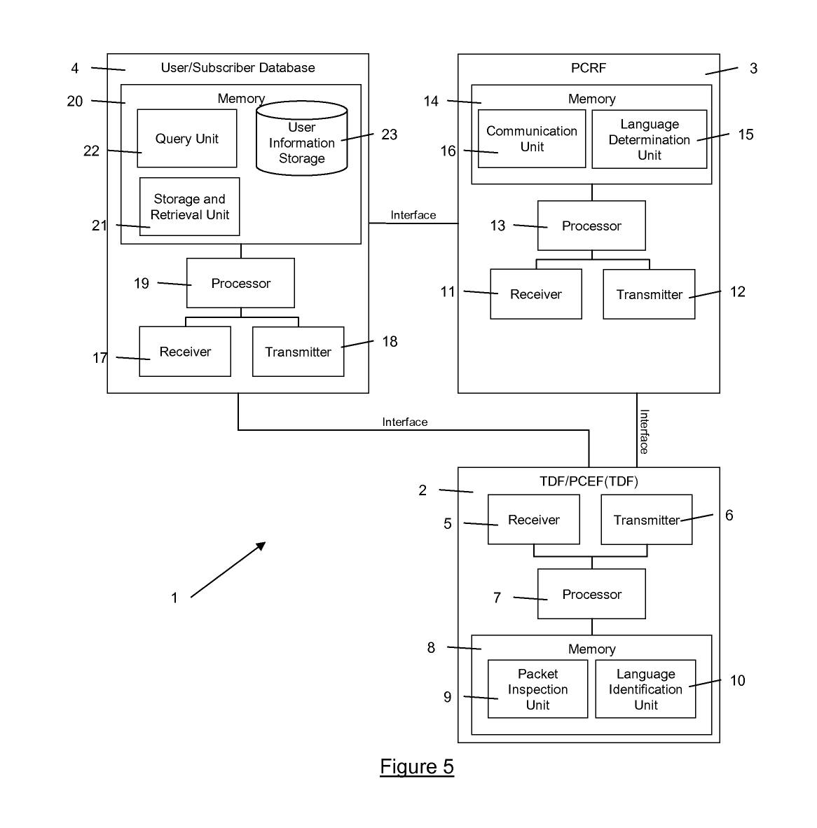

FIG. 5 illustrates schematically an example of a telecommunications network system 1 suitable for implementing the methods described above. The network 1 includes a Traffic Detection Function 2, a PCRF 3 and a User/Subscriber Database 4. Each of these components/nodes can be implemented as a combination of computer hardware and software.

The Traffic Detection Function 2 comprises a receiver 5, a transmitter 6, a processor 7 and a memory 8. The memory 8 stores the various programs/executable files that are implemented by the processor, and also provides a storage unit for any required data. The programs/executable files stored in the memory, and implemented by the processor, include a packet inspection unit 9 and a language identification unit 10.

The PCRF 3 comprises a receiver 11, a transmitter 12, a processor 13 and a memory 14. The memory 14 stores the various programs/executable files that are implemented by the processor 13, and also provides a storage unit for any required data. The programs/executable files stored in the memory, and implemented by the processor, include a language determination unit 15 and a communication unit 16. The language determination unit 15 is configured to obtain a user's language information, retrieving the information from the memory 14 or from the user database 4, and to select a language to be used for the message that is to be sent to the user. The communication unit 16 is configured to generate the message that is to be sent to the user using the language selected by the language unit 15.

The user/subscriber database 4 comprises a receiver 17, a transmitter 18, a processor 19 and a memory 20. The memory 20 stores the various programs/executable files that are implemented by the processor 19, and also provides a storage unit for any required data. The programs/executable files stored in the memory, and implemented by the processor, include a storage and retrieval unit 21 and a query unit 22. The memory also provides a user information storage 23 that stores the user/subscriber records. The storage and retrieval unit 21 is configured to implement storage of any received language information associated with a user in a record that relates to that user and to retrieve the language information for a user's record. The query unit 22 is configured to handle any queries received by the database that relate to user information stored in the database.

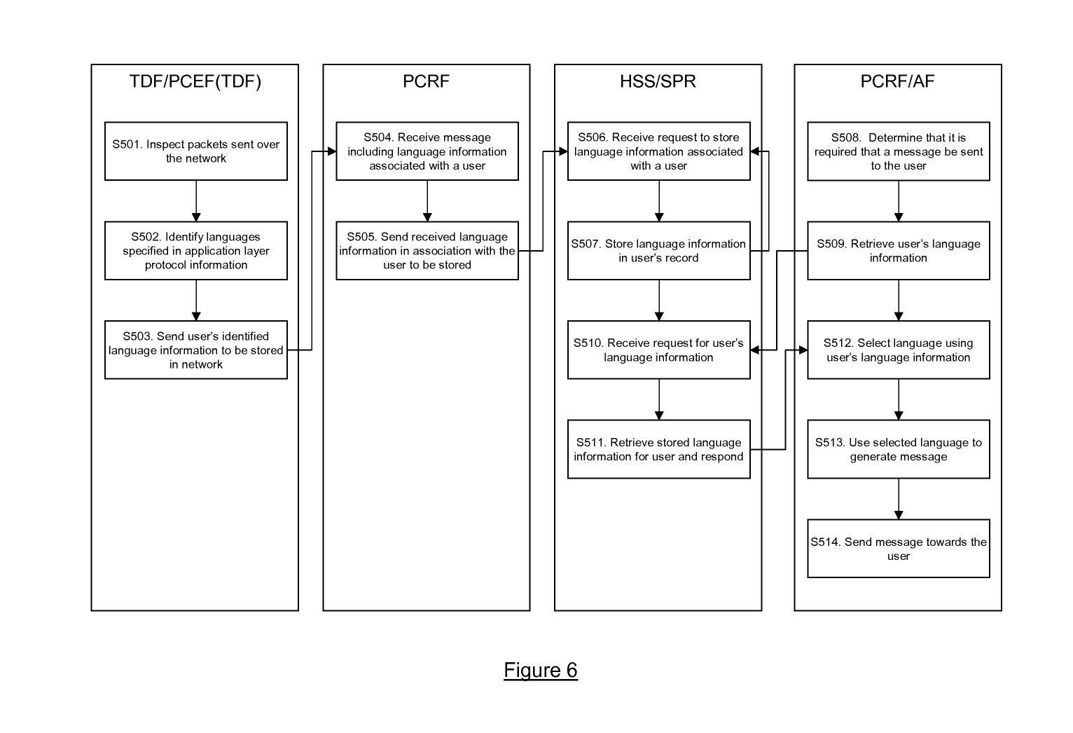

FIG. 6 is a flow diagram illustrating an example of the process of a network determining the preferred language of a user of the network and using this information to communicate with user. The steps performed are as follows:
S501. The packet inspection unit 9 of the TDF 2 performs packet inspection on packets sent over the network from a terminal used by a user.
S502. As a result of the packet inspection, the language identification unit 10 is able to identify any languages that are specified within application layer protocol information contained in the packets.
S503. The Traffic Detection Function 2 then generates and sends a message to the PCRF using the transmitter 6. The message includes information regarding the identified languages and associates the identified language information with the user.
S504. The PCRF 3 receives the message from the TDF 2 using the receiver 11.
S505. The PCRF 3 then generates and sends a further message to the user database 4 using the transmitter 12. This further message requests storage of the user's language information in a user record that relates to the user and includes the identified language information (i.e. received in the message from the TDF).
S506. The user database 4 receives the message including the user's language information from the PCRF using the receiver 17.
S507. The storage and retrieval unit 21 implements storage of the language information in the user's user record within the memory 20.
S508. The PCRF 3 or a separate AF determines that it is required to send a message to the user.
S509. The PCRF/AF therefore sends a query to the user database 4 in order to retrieve the user's language information.
S510. The user database 4 receives the query from the PCRF/AF using its receiver 17, the query identifying the user and requesting language information for the user.
S511. The query unit 22 handles the query, and uses the storage and retrieval unit 21 to retrieve the language information that has been stored for the user from the memory 20. The user database 4 then sends a response to the PCRF/AF using the transmitter 18, the response including the retrieved language information.
S512. The PCRF/AF receives the response from the user database, the response including the language information for the user, and uses the received language information to select a language that is to be used for the message that is to be sent to the user.
S513. The PCRF/AF then uses the selected language to generate the message.
S514. The PCRF/AF then sends the messages towards a terminal used by the user. The terminal to which the PCRF/AF sends the message may be the same terminal as that which generated the packets that were inspected by the TDF in order to identify any languages that may be associated with the user. Alternatively, the terminal to which the PCRF/AF sends the message may be a different terminal to that which generated the packets that were inspected by the TDF.

The methods and apparatus described above provide that a network operator can dynamically determine a language that should be used when communicating with a user of the network, and thereby ensure that the user will be able to understand any messages sent by the network operator. Furthermore, the methods and apparatus described above do not require that the network is pre-configured with language information for the user's of the network as the network can determine the appropriate language without any human intervention. The methods and apparatus therefore enable a network to determine the language that should be used for user's who are within their home network and for user's who are roaming in the network. This is particularly useful in regions and/or countries that make use of more than one language, locations in which there is a high density of users that do not speak the native language, and situations which a group subscription may be used for multilingual individuals sharing the same connectivity. This is especially important when emergency (authority to citizen) messages must be sent, e.g., tsunami or tornado alerts, etc.

It will be appreciated by the person of skill in the art that various modifications may be made to the above-described embodiments without departing from the scope of the present invention. For example, a network entity, such as an AF or PCRF, can send the message to the users' mobile device using any suitable delivery mechanism, such as SMS, MMS, Instant Messaging, web page, e-mail, etc. In addition, whilst the above-described embodiments refer to the HTTP, RTSP, SIP and SDP application layer protocols and specific header fields and/or attributes thereof, these methods are equally applicable to any application layer protocols that conveys language information within one or more of its header fields and/or attributes.

1. A method of operating a telecommunications network to determine a language to be used for a message that is to be sent to a terminal of a user of the network, the method comprising:
receiving, at a node, data packets sent over the network from at least one of the terminal of the user towards a server and the server towards the terminal, the sever is different from the node:
inspecting the packets at the node in order to identify at least one language specified within application layer protocol information contained in the packets; and
selecting an identified language as a language that is to be used for the message.

2. The method as claimed in claim 1, further comprising:
storing, at a node of the network, information regarding the at least one identified language in association with the user.

3. A method of operating a node of a telecommunications network, the method comprising:
receiving data packets sent over the network from at least one of a terminal of a user of the network towards a server and the server towards the terminal, the server is different from the node;
inspecting the packets;
identifying, as a result of the inspection, at least one language specified within application layer protocol information contained in the packets; and
sending a message to a further node, the message including information regarding the at least one identified language and associating the identified language information with the user, such that a language to be used for a further message that is to be sent from the network to a terminal used by the user is selected from the at least one identified language.

4. The method as claimed in claim 3, wherein the node is configured to operate as a Traffic Detection Function, TDF.

5. The method as claimed in claim 3, wherein the further node is configured to operate as one of:
a Policy and Charging Rules Function, PCRF; and
a user database, wherein the user database is one of:
a Subscription Profile Repository;
a User Data Repository;
a Home Subscriber Server; and
a Home Location Register.

6. The method as claimed in claim 1, wherein the inspecting of packets comprises:
examining at least one of field values and attribute values of the application layer protocol information contained in the packets in order to detect language tags within the at least one of field values and attribute values of the application layer protocol information.

7. A method of operating a node of a telecommunications network, the method comprising:
receiving a message from a further node that inspects packets sent over the network of at least one of to and from a terminal used by a user, the message including information regarding at least one language identified by the packet inspection executed by the further node on packets at least one of sent from the terminal towards a server and sent from the server towards the terminal, the server is not the further node, and associating the identified language information with the user; and
storing the identified language information in association with the user within one of the node and a user database of the network such that a language to be used for a further message to be sent from the network to a terminal used by the user is selected from the at least one identified language.

8. The method as claimed in claim 7, wherein the storing the identified language information in association with the user comprises:
sending a message to a user database of the network, the message including the received language information and associating the language information with the user.

9. The method as claimed in claim 7, wherein the node is configured to operate as a Policy and Charging Rules Function.

10. The method as claimed in claim 7, wherein the further node is configured to operate as a Traffic Detection Function.

11. A method of operating a user database of a telecommunications network, the method comprising:
receiving a message from a node of the network, the message including information regarding at least one identified language and associating the identified language information with a user, the identified language information having been obtained as a result of inspecting, at one of the node and a further node of the network, packets at least one of sent over the network to and/or from a terminal used by the user towards a server and sent from the server towards the terminal, the server is not the node or the further node;
storing the identified language information in association with the user; and upon receipt of a query for language information associated with the user, responding to the query with the identified language information stored in association with the user such that a language to be used for a further message that is to be sent from the network to a terminal used by the user is selected from the at least one identified language.

12. The method as claimed in claim 11, wherein the step of storing the identified language information in association with the user further comprises includes:
storing the identified language information in one of replacement of and addition to language information previously stored by the user database in association with the user.

13. The method as claimed in claim 11, wherein the storing the identified language information in association with the user further includes:
storing a time stamp with the identified language information, the time stamp providing an indication of the time when the identified language information was stored by the user database.

14. The method as claimed in claim 13, wherein of responding to the query with the identified language information stored in association with the user further includes one of:
selecting, from among the identified language information stored for the user, the identified language information whose time stamp indicates that the identified language information is the most recent identified language information stored for the user; and
selecting, from among the identified language information stored for the user, the identified language information that, according to the respective time stamps, has been used most frequently within a predefined time period.

15. The method as claimed in claim 11, wherein the identified language information is only stored for a period of time.

16. A telecommunications network, comprising:
a first node configured to inspect packets sent over the network at least one of to and/or and from a terminal used by a user at least one of towards a server and from the server towards the terminal, in order to identify at least one language specified within application layer protocol information contained in the packets and to communicate information regarding the at least one identified language associated with the user to another node of the network, the server is not the first node; and
a second node configured to use the identified language information associated with the user to select an identified language as the language to be used for a message that is to be sent by the network to a terminal of the user.

17. An apparatus configured to operate as a node of a telecommunications network, the apparatus comprising:
a packet inspection unit configured to inspect packets sent over the network at least one of to and from a terminal used by a user at least one of towards a server and from the server towards the terminal, the server is not the node;
a language identification unit configured to identify, as a result of the packet inspection, at least one language specified within application layer protocol information contained in the packets; and
a transmitter configured to send a message to a further node, the message including information regarding the at least one identified language and associating the identified language information with the user such that a language to be used for a further message that is to be sent from the network to a terminal used by the user is selected from the at least one identified language.

18. The apparatus as claimed in claim 17, wherein the apparatus is configured to operate as a Traffic Detection Function, TDF.

19. The apparatus as claimed in claim 17, wherein the packet inspection unit is configured to examine at least one of field values and attribute values of the application layer protocol information contained in the packets in order to detect language tags within the at least one of field values and/or and attribute values of the application layer protocol information.

20. An apparatus configured to operate as a node of a telecommunications network, the apparatus comprising:
a receiver configured to receive a message from a further node that inspects packets sent over the network from at least one of a terminal used by a user towards a server and from the server towards the terminal, the server is not the further node, the message including information regarding at least one language identified by the packet inspection and associating the identified language information with the user;
wherein the apparatus is configured to store the identified language information in association with the user within one of a memory of the node and a user database of the network, such that a language to be used for a further message to be sent from the network to a terminal used by the user is selected from the at least one identified language.

21. The apparatus as claimed in claim 20, further comprising a transmitter for sending a further message to the user database of the network, the further message including the received language information and associating the language information with the user.

22. The apparatus as claimed in claim 20, wherein the apparatus is configured to operate as a Policy and Charging Rules Function.

23. An apparatus configured to operate as a user database of a telecommunications network, the apparatus comprising:
a receiver configured to receive a message from a node of the network, the message including information regarding at least one identified language and associating the identified language information with a user, the identified language information having been obtained as a result of one of the node and a further node of the network inspecting packets sent over the network from at least one of a terminal used by the user towards a server and the server towards the terminal, the server is not one of the node and the further node;
a memory configured to store the identified language information in association with the user; and
a query unit configured to, upon receipt of a query for language information associated with the user, respond to the query with the identified language information stored in association with the user such that a language to be used for a further message that is to be sent from the network to a terminal used by the user is selected from the at least one identified language.

24. The apparatus as claimed in claim 23, wherein the apparatus is configured to store the at least one identified language information in one of replacement of and addition to language information previously stored by the user database in association with the user.

25. The apparatus as claimed in claim 23, wherein the apparatus is configured to store a time stamp with the identified language information, the time stamp providing an indication of the time when the identified language information was stored by the user database.

26. The apparatus as claimed in claim 25, wherein, when responding to a query, the query unit is configured to select the identified language information whose time stamp indicates that the identified language information is the most recent identified language information stored for the user.

27. The apparatus as claimed in claim 25, wherein, when responding to a query, the query unit is configured to select, from among the identified language information stored for the user, the identified language information that, according to a plurality of respective time stamps, has been used most frequently within a predefined time period.
